(19) United States
(12) Patent Application Publication
(10) Pub. No.: US 2025/0362668 A1
(43) Pub. Date: Nov. 27, 2025

(54) Rapid-response intelligent scheduling method and system for semiconductor packaging and testing workshop

(71) Applicant: Donghua University, Shanghai (CN)

(72) Inventors: Jie ZHANG, Shanghai (CN); Hong WANG, Shanghai (CN); Peng ZHANG, Shanghai (CN); Youlong LV, Shanghai (CN); Lihui WU, Shanghai (CN); Da CHEN, Shanghai (CN)

(73) Assignee: Donghua University, Shanghai (CN)

(21) Appl. No.: 19/294,356

(22) Filed: Aug. 8, 2025

Related U.S. Application Data
(63) Continuation of application No. PCT/CN2024/133397, filed on Nov. 21, 2024.

(30) Foreign Application Priority Data
Dec. 1, 2023 (CN) 2023116396807

(51) Int. Cl. G05B 19/418

(52) U.S. Cl. CPC G05B 19/41865; G05B 2219/32252; G05B 2219/45031

(57) ABSTRACT

The present disclosure relates to a rapid-response intelligent scheduling method and system for a semiconductor packaging and testing workshop. Workshop operation data is transmitted to a bottleneck identification module by means of a graphical user interface (GUI) module; the bottleneck identification module identifies all bottleneck processes by means of a “buffer-bottleneck index” bottleneck identification method; the GUI module and the bottleneck identification module transmit workshop scheduling data and a bottleneck process identification result to a scheduling module, respectively; an intelligent scheduling sub-module establishes a bottleneck process scheduling model in a semiconductor packaging and testing workshop, and inputs a bottleneck process scheduling solution into a rule-based scheduling sub-module; and the rule-based scheduling sub-module generates a global scheduling solution and transmits the global scheduling solution to the GUI module for arranging production.

### CROSS REFERENCE TO RELATED APPLICATION

The present application is a Continuation Application of PCT application No. PCT/CN2024/133397 filed on Nov. 21, 2024, which claims the benefit of CN2023116396807 filed on December 1, 2023. All the above are hereby incorporated by reference in their entirety for all purposes.

### FIELD OF THE INVENTION

The present disclosure relates to workshop scheduling technology, particularly to a rapid-response intelligent scheduling method and system for a semiconductor packaging and testing workshop.

### BACKGROUND OF THE INVENTION

Semiconductor packaging and testing constitute a crucial segment of semiconductor industry, bearing significant economic value and strategic importance. Semiconductor packaging and testing production is typically regarded as a hybrid flow workshop. The workshop of this kind is characterized by diverse product types, complex processes, numerous equipment units, and lengthy processing cycles, making efficient scheduling particularly challenging. Consequently, research into scheduling for semiconductor packaging and testing workshops holds substantial practical value and theoretical significance. The semiconductor packaging and testing process includes multiple stages: wafer inspection, backside thinning, wafer dicing, die attachment, wire bonding, molding, laser marking, trim and form, plating, and final testing. Among these, die attachment, wire bonding, and molding are generally considered the most critical processes in the packaging and testing workshop, as their processing efficiency significantly impacts the production efficiency of the workshop.

Existing patents (CN109085803A, CN105320105A, CN103246240A) primarily focus on scheduling individual processes within semiconductor packaging and testing. While these approaches can improve processing efficiency for specific production lines by reducing machine changeover time, thereby shortening production cycles and enhancing production benefits, however, they fail to address workshop scheduling from a global perspective and fully investigate the complexities of semiconductor packaging and testing workshop scheduling. In semiconductor packaging and testing enterprises, there is often a mismatch between the orders received and the production capacities of various processes within the workshop. This mismatch leads to the phenomenon of “bottleneck drifting,” where the production bottleneck shifts from one process to another over time. As a result, the processes experiencing “blockage” and “starvation” also keep changing. Scheduling approaches that focus solely on a single process cannot effectively address bottleneck drifting and, therefore, fail to achieve truly efficient scheduling.

### SUMMARY OF THE INVENTION

In response to the problems of work redundancy and low efficiency due to the scheduling work of a semiconductor packaging and testing factory overly focusing on a certain process, the present disclosure provides a rapid-response intelligent scheduling method and system for a semiconductor packaging and testing workshop, for the scheduling of a semiconductor packaging and testing workshop, thereby improving the production efficiency of the workshop. Moreover, as the global scheduling of a semiconductor packaging and testing factory is taken into account, the phenomenon of “bottleneck drifting” occurring in a semiconductor packaging and testing workshop can be mitigated and overcome, thereby improving production benefits.

The technical solutions of the present disclosure are as follows:
A rapid-response intelligent scheduling method for a semiconductor packaging and testing workshop, comprising three modules: a GUI module, a bottleneck identification module, and a scheduling module; wherein the scheduling module comprises an intelligent scheduling sub-module and a rule-based scheduling sub-module, and following steps are accomplished through these modules:
Step 1: a user transmits workshop operation data to the bottleneck identification module by means of the GUI module;
Step 2: the bottleneck identification module identifies all bottleneck processes by means of a “buffer-bottleneck index” bottleneck identification method;
Step 3: the GUI module and the bottleneck identification module transmit workshop scheduling data and a bottleneck process identification result to the scheduling module, respectively;
Step 4: the intelligent scheduling sub-module establishes a bottleneck process scheduling model in a semiconductor packaging and testing workshop, utilizes an IAHA to schedule the bottleneck processes, and inputs a bottleneck process scheduling solution into the rule-based scheduling sub-module; and
Step 5: based on a rule library, the user selects rules for each process in advance; and combining the bottleneck process scheduling solution obtained from the intelligent scheduling sub-module, the rule-based scheduling sub-module generates a global scheduling solution and transmits the global scheduling solution to the GUI module for arranging production.

Further, Step 2 is specifically as follows:
Step 2.1: determining whether there is an accumulation of work-in-progress in a buffer of process s (s∈1 . . . S, wherein S denotes the total number of processes), wherein if yes, the process is identified as a bottleneck process, and Step 2.3 is performed; otherwise, Step 2.2 is performed;
Step 2.2: calculating a bottleneck index for each process using Formula (1) and Formula (2), and determining whether the process has a highest bottleneck index, wherein if yes, Step 2.3 is performed; otherwise, Step 2.4 is performed;

$${I}_{B N} = {w}_{t} \times \frac{{l}_{s}}{{c}_{s}} + {w}_{b} \times \frac{{B}_{s}^{i n}}{{B}_{s}^{a l l}} + {w}_{q} \times {G}_{s ( {q}_{a c} )} , s = 1 , … , S \qquad ( 1 )$$

$${c}_{s} = {T}_{s} - {F}_{s} ( t ) \qquad ( 2 )$$

wherein I_{BN} denotes the bottleneck index; wₜ, w_{b}, and w_{q} denote influence weights of the number of products produced by the process, the process buffer, and product quality on a bottleneck degree, respectively, satisfying wₜ+w_{b}+w_{q}=1; cₛ and lₛ denote production capacity and a production load, respectively; Tₛ denotes assumed available processing capacity; Fₛ(t) denotes a variation quantity in the production capacity of process s due to changes in actual production conditions;

$${B}_{s}^{a l l}$$

and

$${B}_{s}^{i n}$$

denote a maximum loadable quantity of the buffer and the quantity of newly added products in the buffer, respectively; G_{s(g}_{_{ac}}₎ denotes an influence function of quality assurance capability (q_{ac}) on the bottleneck degree; and (q_{ac}) is a comprehensive reflection of the quality capability and quality requirements;
Step 2.3: recording the process as a bottleneck process and performing Step 2.5;
Step 2.4: recording the process as a non-bottleneck process and performing Step 2.5;
Step 2.5: determining whether the process is the last one; wherein if yes, Step 2.6 is performed; otherwise, Step 2.1 is performed; and
Step 2.6: terminating the determination and outputting all bottleneck processes to the scheduling module.

Further, Step 4 is specifically as follows:
Step 4.1: establishing a bottleneck process scheduling model in a semiconductor packaging and testing workshop, with the model comprising all bottleneck processes and processes between them;
Step 4.2: optimizing the bottleneck process scheduling model in the workshop using an IAHA;
Step 4.2.1: initializing a population by means of an improved Nawaz, Enscore, and Ham (NEH) heuristic rule instead of randomly generating an initial population;
Step 4.2.2: initializing a food source visit table;
Step 4.2.3: setting an iteration count to Iteration and utilizing the IAHA to conduct an optimization search;
Step 4.2.4: replacing a 50% probability-based guided foraging method or territorial foraging method with an improved foraging method based on a foraging determination formula;
Step 4.2.5: determining the iteration count, wherein if the iteration count is a multiple of a predefined migration coefficient n, enhanced taboo territorial foraging is performed;
Step 4.2.6: determining the iteration count, wherein if the iteration count exceeds a predefined migration coefficient 2n, migration foraging is performed;
Step 4.2.7: outputting an individual with an optimal fitness value, i.e., an optimal bottleneck process scheduling solution; and
Step 4.3: outputting the bottleneck process scheduling solution through the intelligent scheduling sub-module.
Further, Step 4.2.1 is specifically as follows:
Step 4.2.1.1: calculating total processing time for all orders as

$$T {P}_{j} = \sum \frac{{P}_{j , i}}{\sum {v}_{k , j}} ,$$

wherein j∈2 . . . n, representing a sum of ratios of an order's processing time at each stage to a sum of processing speeds at each stage; and permuting the orders in non-increasing order of TPⱼ to obtain an initial sequence π⁰={π⁰(1), π⁰(2), . . . , π⁰(n)};
Step 4.2.1.2: extracting first two orders π⁰(1) and π⁰(2) from π⁰ and permuting their order to obtain two possible schedules {π⁰(1), π⁰(2)} and {π⁰(2), π⁰(1)}; evaluating the two partial schedules and selecting the one with a smaller makespan as a current schedule, denoted as π={π(1), π(2)};
Step 4.2.1.3: extracting a j-th order π⁰(j) from π⁰ and inserting it into all possible positions of π to obtain j partial permutations; evaluating these partial permutations and selecting the one with a smallest makespan as the current schedule π;
Step 4.2.1.4: setting j=j+1, wherein if j≤n−1, Step 4.2.1.3 is performed; otherwise, the current schedule π is output;
Step 4.2.1.5: based on the current schedule π={π(1), π(2), . . . , π(n)}, randomly selecting integers l, and m such that l<m≤n, and swapping l-th and m-th orders in the current schedule π to obtain a new individual;
Step 4.2.1.6: repeating Step 4.2.1.5 until a set of hummingbird individuals with a size of Popsize/2 is generated; and
Step 4.2.1.7: directly generating another Popsize/2 identical hummingbird individuals using a result of an improved NEH heuristic algorithm, and combining them with the set of individuals generated in Step 4.2.1.6 to obtain an initial population.

Further, Step 4.2.4 is specifically as follows:
Step 4.2.4.1: selecting a foraging method using a foraging determination formula;
wherein original 50% probability-based foraging methods are replaced through the foraging determination formula for choosing between guided foraging and territorial foraging, facilitating an increased selection probability for the guided foraging in early iterations to enhance global exploration capability, while improving an increased selection probability for the territorial foraging in later iterations to strengthen local optimization performance;

$$G T = G {T}_{max} - ( G {T}_{max} - G {T}_{min} ) \times \frac{it}{Iteration} \qquad ( 10 )$$

$$\{ \begin{matrix}{v}_{i} ( t + 1 ) = {{f}_{Guided} ( {v}_{i , tar} ( t ) , {x}_{i} ( t ) )}_{, rand \geq GT} \\ {v}_{i} ( t + 1 ) = {{f}_{Territoriai} ( {x}_{i} ( t ) )}^{, rand < GT}\end{matrix} \qquad ( 11 )$$

wherein GT denotes a foraging determination coefficient; GTₘₐₓ and GTₘᵢₙ denote maximum and minimum foraging determination coefficients, respectively, with values ranging in

$$[ 0 , 0.5 \times \frac{{Popsize}_{\geq mean}}{Pops i z e} ] ,$$

wherein Popsize denotes a population size, and Popsize_{≥mean} denotes the number of individuals in the population whose fitness values are greater than or equal to an average fitness value of the population; it denotes the iteration count; Iteration denotes a maximum iteration count; vᵢ(t+1) denotes a candidate food source position of an i-th hummingbird at time t+1; f_{Guided}(v_{i,tar}(t), xᵢ(t)) denotes a guided foraging search, wherein xᵢ(t) denotes a food source position of the i-th hummingbird at time t; v_{i,tar}(t) denotes a target food source position that the i-th hummingbird intends to visit; and f_{Territorial}(xᵢ(t)) denotes a territorial foraging search;
Step 4.2.4.2: searching for better food sources through three flight modes;
wherein when a generated random number rand≥GT, hummingbirds choose the guided foraging, comprising three flight modes: selecting one processing position to swap two orders, selecting multiple consecutive positions to swap two order blocks, and selecting multiple positions to swap multiple orders; and
when the generated random number rand<GT, the hummingbirds choose the territorial foraging, comprising three flight modes: selecting two positions to swap two orders, selecting multiple consecutive positions to swap intra-block orders, and selecting multiple positions to swap multiple orders; and
Step 4.2.4.3: updating the population and the visit table;
wherein a position of an i-th food source is updated as follows:

$${x}_{i} ( t + 1 ) = \{ \begin{matrix}{x}_{i} ( t ) & {}_{, fitness ( {x}_{i} ( t ) ) \leq {v}_{i} ( t + 1 )} \\ {v}_{i} ( t + 1 ) & {}^{{, fitness ( {x}_{i} ( t ) ) > {v}_{i} ( t + 1 )}_{}}\end{matrix} \qquad ( 12 )$$

wherein fitness(*) denotes the fitness value of a hummingbird, and if the candidate food source has lower fitness than a current food source, the hummingbird abandons the current food source and stays at a newly generated candidate food source vᵢ(t+1) for feeding; and the visit table is updated accordingly.

Further, Step 4.2.5 is specifically as follows:
Step 4.2.5.1: determining the number of hummingbirds for enhanced foraging by selecting a random integer randint (randint∈[2,3,4,5]), and calculating the number of enhanced foraging of each hummingbird as RSₙᵤₘ (RSₙᵤₘ=Popsize/randint);
Step 4.2.5.2: selecting hummingbirds for enhanced territorial foraging using a roulette wheel selection method;
Step 4.2.5.3: performing enhanced taboo territorial foraging for each selected hummingbird for RSₙᵤₘ times, with the enhanced taboo territorial foraging method incorporating a taboo list based on the territorial foraging to ensure each search result for the enhanced taboo territorial foraging is distinct; and
Step 4.2.5.4: updating the population and the visit table.

Further, Step 4.2.6 is specifically as follows:
Step 4.2.6.1: selecting the hummingbird with a worst fitness value and migrating it to a position of the hummingbird that has demonstrated an optimal fitness value thus far; and
Step 4.2.6.2: updating the visit table.

Further, Step 5 is specifically as follows:
a heuristic rule library of the rule-based scheduling sub-module comprises a heuristic processing sequence rule library and a heuristic equipment unit selection rule library;
the processing sequence rule library comprises rules such as a shortest-processing-time-first rule, a longest-processing-time-first rule, a first-in-first-out rule, and an earliest-due-date-first rule, among others;
the equipment unit selection rule library comprises rules such as selecting an equipment unit with shortest processing time, selecting an equipment unit with shortest machine changeover time, selecting an equipment unit with highest precision, selecting an equipment unit with lowest precision, selecting an equipment unit capable of processing most order types, selecting an equipment unit capable of processing fewest order types, among others;
Step 5.1: selecting corresponding heuristic rules for each process in advance;
Step 5.2: generating a global scheduling solution using the processing sequence rule and the equipment unit selection rule for each process; and
Step 5.3: transmitting the global scheduling solution to the GUI module for arranging production.

A rapid-response intelligent scheduling system for a semiconductor packaging and testing workshop, comprising three parts: a GUI module, a bottleneck identification module, and a scheduling module; and configured to implement the aforementioned rapid-response intelligent scheduling method for a semiconductor packaging and testing workshop; wherein

the GUI module is configured to transmit workshop operation data and workshop scheduling data, and receive a global scheduling solution;

the bottleneck identification module identifies all bottleneck processes by means of a “buffer-bottleneck index” bottleneck identification method; and

the scheduling module comprises an intelligent scheduling sub-module and a rule-based scheduling sub-module, the intelligent scheduling sub-module generates a bottleneck process scheduling solution by solving bottleneck process scheduling problems using an IAHA, and the rule-based scheduling sub-module generates the global scheduling solution by combining rules selected by a user from rule libraries with the bottleneck process scheduling solution.

Further, the system also comprises a memory and a processor, wherein the memory stores a computer program, and when executing the computer program, the processor implements the “buffer-bottleneck index” bottleneck identification method of the bottleneck identification module, the IAHA of the intelligent scheduling sub-module of the scheduling module, and the rule-based scheduling sub-module of the scheduling module.

### Beneficial Effects of the Present Disclosure

The present disclosure provides a rapid-response intelligent scheduling method and system for a semiconductor packaging and testing workshop, relating to the field of workshop scheduling. By considering the global scheduling of a semiconductor packaging and testing factory, the present disclosure establishes a scheduling model for a semiconductor packaging and testing workshop. It employs the “buffer-bottleneck index” bottleneck identification method to select bottleneck processes, establishes a bottleneck process scheduling model in a semiconductor packaging and testing workshop, and utilizes an IAHA to solve bottleneck processes. Additionally, the present disclosure leverages a heuristic rule library to complement the scheduling of missing processes, thereby completing the scheduling for the entire workshop. The present disclosure effectively addresses the optimization problem of scheduling in a semiconductor packaging and testing production workshop, shortens the production cycle of bottleneck processes, enhances the processing efficiency of a production line, and ultimately improves the production efficiency of the semiconductor packaging and testing workshop.

### BRIEF DESCRIPTION OF DRAWINGS

FIG. 1 is an overall design diagram of a rapid-response intelligent scheduling method and system for a semiconductor packaging and testing workshop according to the present disclosure.

FIG. 2 is a flowchart of the “buffer-bottleneck index” bottleneck identification method according to the present disclosure.

FIG. 3 is a flowchart of an improved artificial hummingbird algorithm (IAHA) according to the present disclosure.

FIG. 4 is a demonstration diagram illustrating an implementation of three flight modes of improved guided foraging according to the present disclosure.

FIG. 5 is a demonstration diagram illustrating an implementation of three flight modes of improved territorial foraging according to the present disclosure.

FIG. 6 is a Gantt chart illustrating four scheduling methods for bottleneck processes according to the present disclosure.

### DETAILED DESCRIPTION

Below is a detailed description of the present disclosure with reference to the accompanying drawings and specific examples. The examples are implemented based on the technical solutions of the present disclosure, providing detailed embodiments and specific operational processes. However, the scope of the present disclosure is not limited to the following examples.

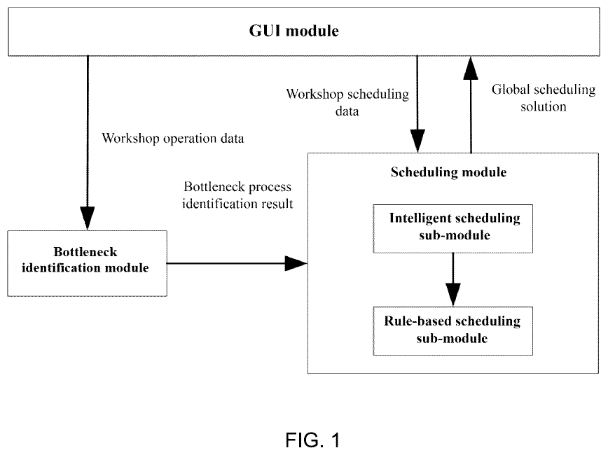

The present disclosure provides a rapid-response intelligent scheduling method and system for a semiconductor packaging and testing workshop, comprising three parts: a graphical user interface (GUI) module, a bottleneck identification module, and a scheduling module, as illustrated in FIG. 1.

The GUI module is configured to transmit workshop operation data and workshop scheduling data, and receive a global scheduling solution; the bottleneck identification module identifies all bottleneck processes by means of a “buffer-bottleneck index” bottleneck identification method; and the scheduling module comprises an intelligent scheduling sub-module and a rule-based scheduling sub-module, the intelligent scheduling sub-module generates a bottleneck process scheduling solution by solving bottleneck process scheduling problems using an IAHA, and the rule-based scheduling sub-module generates the global scheduling solution by combining rules selected by a user from rule libraries with the bottleneck process scheduling solution.

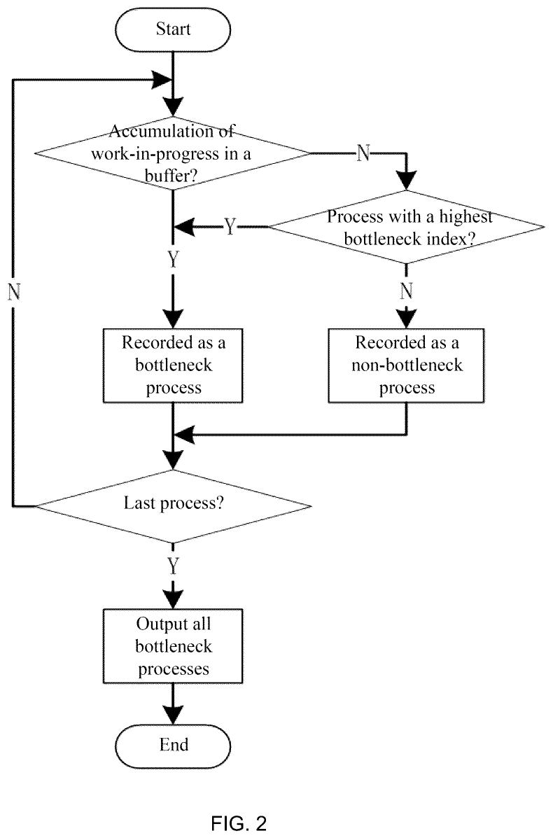

A scheduling process of the system involves the following steps:
Step 1: a user transmitted the workshop operation data to the bottleneck identification module by means of the GUI module.
Step 2: the bottleneck identification module identified all bottleneck processes by means of the “buffer-bottleneck index” bottleneck identification method; an identification process followed the flowchart shown in FIG. 2, relevant data of the bottleneck indices for each process in a semiconductor packaging and testing workshop involved in the present disclosure was presented in Table 1, and the specific steps were as follows:

TABLE 1
Relevant Data of Bottleneck Indices for Each Process

| | | | | Quantity | | | |
|---|---|---|---|---|---|---|---|
| | | | | of Newly | Maximum | | |
| | | | | Added | Loadable | | Bottleneck |
| | Production | Production | Load | Products | Quantity | Buffer | Index |
| Process | Capacity | Load | Ratio | in a Buffer | of a Buffer | Ratio | I_{BN} |
| Wafer | 4500 | 3200 | 81.00% | 0 | 9000 | 0 | 0.405 |
| Inspection | | | | | | | |
| Backside | 4200 | 3200 | 75.00% | 0 | 4200 | 0 | 0.375 |
| Thinning | | | | | | | |
| Wafer | 4000 | 3200 | 83.00% | 0 | 4000 | 0 | 0.415 |
| Dicing | | | | | | | |
| Die | 3500 | 3000 | 85.71% | 200 | 7000 | 2.86% | 0.443 |
| Attachment | | | | | | | |
| Wire | 3500 | 2850 | 81.43% | 150 | 7000 | 2.14% | 0.418 |
| Bonding | | | | | | | |
| Molding | 4000 | 2750 | 68.75% | 100 | 8000 | 1.25% | 0.350 |
| Laser | 4100 | 2750 | 52.05% | 0 | 4100 | 0 | 0.260 |
| Marking | | | | | | | |
| Trim and | 4000 | 2750 | 53.24% | 0 | 4000 | 0 | 0.266 |
| Form | | | | | | | |
| Plating | 4200 | 2750 | 50.58% | 0 | 4200 | 0 | 0.253 |
| Final | 4600 | 2750 | 52.76% | 0 | 4600 | 0 | 0.264 |
| Testing | | | | | | | |

Step 2.1: whether there was an accumulation of work-in-progress (WIP) in a buffer of process s (s∈1 . . . S, wherein S denoted the total number of processes) was determined, wherein if yes, the process was identified as a bottleneck process, and Step 2.3 was performed; otherwise, Step 2.2 was performed.
Step 2.2: a bottleneck index for each process was calculated using Formula (1) and Formula (2), and whether the process had a highest bottleneck index was determined, wherein if yes, Step 2.3 was performed; otherwise, Step 2.4 was performed;

$${I}_{BN} = {w}_{t} \times \frac{{l}_{s}}{{c}_{s}} + {w}_{b} \times \frac{{B}_{s}^{in}}{{B}_{s}^{all}} + {w}_{q} \times {G}_{s ( {q}_{ac} )} , s = 1 , … , S \qquad ( 1 )$$

$${c}_{s} = {T}_{s} - {F}_{s} ( t ) \qquad ( 2 )$$

wherein I_{BN} denoted the bottleneck index; wₜ, w_{b}, and w_{q} denoted influence weights of the number of products produced by the process, the process buffer, and product quality on a bottleneck degree, respectively, satisfying wₜ+w_{b}+w_{q}=1; cₛ and lₛ denoted production capacity and a production load (actual processing quantity), respectively; Tₛ denoted assumed available processing capacity; Fₛ(t) denoted a variation quantity in the production capacity of process s due to changes in actual production conditions;

$${B}_{s}^{all} and {B}_{s}^{in}$$

denoted a maximum loadable quantity of the buffer and the quantity of newly added products in the buffer, respectively; G_{s(q}_{_{ac}}₎ denoted an influence function of quality assurance capability (q_{ac}) on the bottleneck degree; and (q_{ac}) was a comprehensive reflection of the quality capability and quality requirements.
Step 2.3: the process was recorded as a bottleneck process and Step 2.5 was performed.
Step 2.4: the process was recorded as a non-bottleneck process and Step 2.5 was performed.
Step 2.5: whether the process was the last one was determined; wherein if yes, Step 2.6 was performed; otherwise, Step 2.1 was performed.
Step 2.6: the determination was terminated and all bottleneck processes were output to the scheduling module;
wherein through the “buffer-bottleneck index” bottleneck identification method, three consecutive processes—die attachment, wire bonding, and molding—were identified as bottlenecks due to the accumulation of products in the buffer; weighting values were set as wₜ=0.5, w_{b}=0.5, and w_{q}=0, and the die attachment process was found to have a highest bottleneck index I_{BN} of 0.443; and consequently, in this particular case, the bottleneck processes were determined to be die attachment, wire bonding, and molding.
Step 3: the GUI module and the bottleneck identification module transmitted the workshop scheduling data and a bottleneck process identification result to the scheduling module, respectively.
Step 4: the intelligent scheduling sub-module established a bottleneck process scheduling model in the semiconductor packaging and testing workshop, utilized an IAHA to schedule the bottleneck processes, and input a bottleneck process scheduling solution into the rule-based scheduling sub-module; and the specific steps were as follows:
Step 4.1: a bottleneck process scheduling model in the semiconductor packaging and testing workshop was established, with the model comprising all bottleneck processes and processes between them;
wherein definitions of the parameter symbols in the mathematical model were as follows:
N—total number of orders, with i as an index for each order;
K—total number of processing stages, with k as an index for each stage;
mₖ—total number of equipment units in stage k;
W_{i,k}—processing time of order i in stage k;
P_{i,k,j}—processing time of order i on equipment unit j in stage k;
v_{k,j}—speed of equipment unit j in stage k;
B_{i,k,j}—beginning time of order i on equipment unit j in stage k;
E_{i,k,j}—ending time of order i on equipment unit j in stage k;
Cᵢ—completion time of order i with Cₘₐₓ as maximum completion time;
X_{i,k,j}—variable that took the value of 1 if order i had been scheduled to be processed on equipment unit j in stage k, and 0 otherwise.

Further, an objective function of the workshop scheduling model was given by Formula (3):

$$fitness = {w}_{1} * {C}_{max} + {w}_{2} * Cost + {w}_{3} * Tardiness \qquad ( 3 )$$

wherein fitness denoted a weighted scheduling objective; w₁, w₂, and w₃ denoted weighting values for maximum processing time, processing cost, and average tardiness time, respectively, with w₁+w₂+w₃=1; the specific values of these weights were determined based on the actual conditions of different semiconductor packaging and testing production workshops, and in this case, the weighting values were set as w₁=1, w₂=0, and w₃=0; Cₘₐₓ, Cost, and Tardiness denoted the maximum processing time, the processing cost, and the average tardiness time, respectively.

The constraints of the mathematical model were described as follows:

$${E}_{i , k , j} ⩽ {B}_{i , k + 1 , j} \qquad ( 4 )$$

$${\sum }_{j = 1}^{{m}_{k}} {X}_{i , k , j} = 1 \qquad ( 5 )$$

$${P}_{i , k , j} = {\sum }_{j = 1}^{{m}_{k}} {X}_{i , k , j} \frac{{W}_{i k j}}{{v}_{k , j}} \qquad ( 6 )$$

$${E}_{i 2 , k , j} = {B}_{i 2 , k , j} + {P}_{i 2 , k , j} \qquad ( 7 )$$

$${C}_{i} = {E}_{i , K , j} \qquad ( 8 )$$

wherein Formula (3) represented the objective function; Formula (4) represented that for each order, the beginning time of a current process was after the ending time of a preceding process; Formula (5) represented that each process for each order was processed on only one equipment unit; Formula (6) represented the completion time of an order in each process; Formula (7) represented the completion time of an order as a sum of its processing beginning time and the processing time in that particular stage; and Formula (8) represented that the final completion time of an order was equal to its processing ending time in stage k.

Relevant data of workshop scheduling in the bottleneck processes was presented in Table 2 and Table 3. Table 2 provided processing time data for workshop scheduling orders of the bottleneck processes, recording a production volume of 20 orders and basic processing times for corresponding chip models in the three bottleneck processes: die attachment, wire bonding, and molding. The basic processing times represented the time required to process 10,000 chips. Table 3, on the other hand, presented processing rate data for the workshop equipment units in the bottleneck processes, recording the number of scheduled equipment units and the number of equipment units with different processing rates.

TABLE 2
Processing Time Data for Workshop Scheduling
Orders of Bottleneck Processes

| | | Basic Processing Time (min/10,000) | | |
|---|---|---|---|---|
| | Production | Die | | |
| Order No. | Volume/10,000 | Attachment | Wire Bonding | Molding |
| 1 | 1.7 | 55 | 41 | 40 |
| 2 | 2.1 | 47 | 53 | 39 |
| 3 | 2.4 | 45 | 57 | 36 |
| 4 | 4.2 | 46 | 46 | 35 |
| 5 | 3 | 55 | 54 | 35 |
| 6 | 3.7 | 46 | 56 | 32 |
| 7 | 1.8 | 46 | 40 | 34 |
| 8 | 3 | 45 | 43 | 37 |
| 9 | 4.1 | 45 | 43 | 32 |
| 10 | 3.1 | 45 | 60 | 39 |
| 11 | 4.4 | 48 | 58 | 35 |
| 12 | 4.2 | 46 | 42 | 36 |
| 13 | 2.6 | 48 | 45 | 39 |
| 14 | 1.5 | 55 | 51 | 37 |
| 15 | 3.8 | 46 | 43 | 31 |
| 16 | 1.8 | 53 | 41 | 32 |
| 17 | 1.5 | 53 | 52 | 30 |
| 18 | 3.7 | 51 | 50 | 30 |
| 19 | 4.1 | 51 | 50 | 40 |
| 20 | 4 | 53 | 51 | 36 |

TABLE 3
Processing Rate Data for Workshop Equipment
Units in Bottleneck Processes

| | |
|---|---|
| | Relationship with the |
| Number of | Basic Processing Rate |

| Process | Equipment Units | 1 Time | 1.1 Times |
|---|---|---|---|
| Die Attachment | 4 | 1 | 3 |
| Wire Bonding | 4 | 0 | 4 |
| Molding | 3 | 1 | 2 |

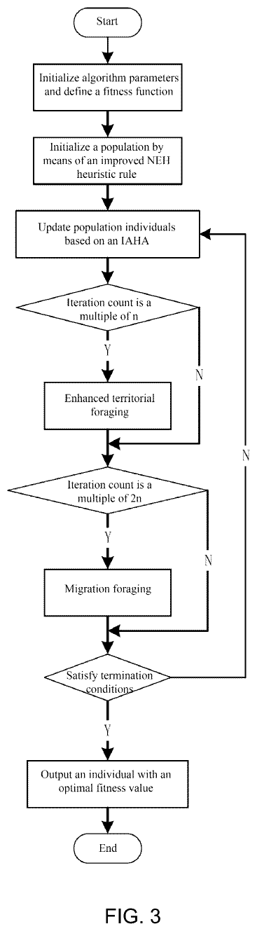

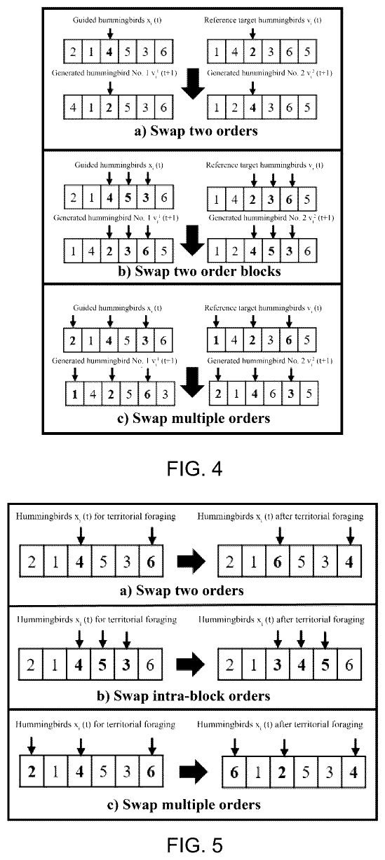

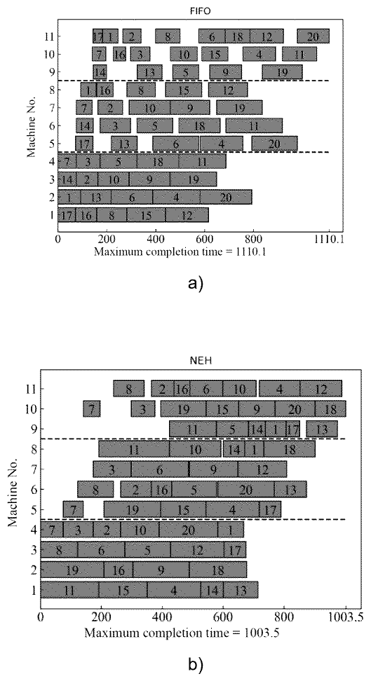

Step 4.2: the bottleneck process scheduling model in the workshop was optimized using an IAHA shown in FIG. 3.
Step 4.2.1: a population was initialized by means of an improved Nawaz, Enscore, and Ham (NEH) heuristic rule instead of randomly generating an initial population.
Step 4.2.1.1: total processing time for all orders was calculated as

$$T {P}_{j} = \sum \frac{{p}_{j , i}}{\sum {v}_{k , j}} ,$$

wherein j∈2 . . . n, representing a sum of ratios of an order's processing time at each stage to a sum of processing speeds at each stage; and the orders were permuted in non-increasing order of TPⱼ to obtain an initial sequence π⁰={π⁰(1), π⁰(2), . . . , π⁰(n)}.
Step 4.2.1.2: first two orders π⁰(1) and π⁰(2) were extracted from π⁰ and their order was permuted to obtain two possible schedules {π⁰(1), π⁰(2)} and {π⁰(2), π⁰(1)}; the two partial schedules were evaluated and the one with a smaller makespan was selected as a current schedule, denoted as π={π(1), π(2)}; and j=3 was set.
Step 4.2.1.3: a j-th order π⁰(j) was extracted from π⁰ and was inserted into all possible positions of π to obtain j partial permutations; these partial permutations were evaluated and the one with a smallest makespan was selected as the current schedule π.
Step 4.2.1.4: j=j+1 was set, wherein if j≤n−1, Step 4.2.1.3 was performed; otherwise, the current schedule π was output.
Step 4.2.1.5: based on the current schedule π={π(1), π(2), . . . , π(n)}, integers l, and m were randomly selected such that l<m≤n, and l-th and m-th orders were swapped in the current schedule π to obtain a new individual.
Step 4.2.1.6: Step 4.2.1.5 was repeated until a set of hummingbird individuals with a size of Popsize/2 was generated.
Step 4.2.1.7: another Popsize/2 identical hummingbird individuals were directly generated using a result of an improved NEH heuristic algorithm, and they were combined with the set of individuals generated in Step 4.2.1.6 to obtain an initial population.
Step 4.2.2: a food source visit table was initialized;

$${VT}_{i , j} = \{ \begin{matrix}0 & if i \neq j \\ null & i = j\end{matrix} i = 1 , … , n ; j = 1 , … , n \qquad ( 9 )$$

wherein if i=j, VT_{i,j}=null represented that the hummingbird was feeding at a particular food source; and if i≠j, VT_{i,j}=0 represented that an i-th hummingbird visited a j-th food source during a current iteration.
Step 4.2.3: an iteration count was set to Iteration and the IAHA was utilized to conduct an optimization search.
Step 4.2.4: a 50% probability-based guided foraging method or territorial foraging method was replaced with an improved foraging method based on a foraging determination formula.
Step 4.2.4.1: a foraging method was selected using a foraging determination formula;
wherein original 50% probability-based foraging methods were replaced through the foraging determination formula for choosing between guided foraging and territorial foraging, facilitating an increased selection probability for the guided foraging in early iterations to enhance global exploration capability, while improving an increased selection probability for the territorial foraging in later iterations to strengthen local optimization performance;

$$GT = {GT}_{max} - ( {GT}_{max} - {GT}_{min} ) \times \frac{it}{Iteration} \qquad ( 10 )$$

$$\{ \begin{matrix}{v}_{i} ( t + 1 ) = {f}_{Guided} ( {v}_{i , tar} ( t ) , {x}_{i} ( t ) ) , rand \geq GT \\ {v}_{i} ( t + 1 ) = {f}_{Territorial} ( {x}_{i} ( t ) ) , rand < GT\end{matrix} \qquad ( 11 )$$

wherein GT denoted a foraging determination coefficient; GTₘₐₓ and GTₘᵢₙ denoted maximum and minimum foraging determination coefficients, respectively, with values ranging in

$$[ O , 0.5 \times \frac{{Popsize}_{\geq mean}}{Popsize} ] ,$$

wherein Popsize denoted a population size, and Popsize_{≥mean} denoted the number of individuals in the population whose fitness values were greater than or equal to an average fitness value of the population; it denoted the iteration count; Iteration denoted a maximum iteration count; vᵢ(t+1) denoted a candidate food source position of the i-th hummingbird at time t+1; f_{Guided}(v_{i,tar}(t), xᵢ(t) denoted a guided foraging search, wherein xᵢ(t) denoted a food source position of the i-th hummingbird at time t; v_{i,tar}(t) denoted a target food source position that the i-th hummingbird intended to visit; and f_{Territorial}(xᵢ(t)) denoted a territorial foraging search.
Step 4.2.4.2: the hummingbirds searched for better food sources through three flight modes;
wherein when a generated random number rand≥GT, the hummingbirds chose the guided foraging, as shown in FIG. 4; the guided foraging comprised three flight modes: selecting one processing position to swap two orders, selecting multiple consecutive positions to swap two order blocks, and selecting multiple positions to swap multiple orders; and
when the generated random number rand<GT, the hummingbirds chose the territorial foraging as shown in FIG. 5; the territorial foraging comprised three flight modes: selecting two positions to swap two orders, selecting multiple consecutive positions to swap intra-block orders, and selecting multiple positions to swap multiple orders.
Step 4.2.4.3: the population and the visit table were updated;
wherein a position of an i-th food source was updated as follows:

$${x}_{i} ( t + 1 ) = \{ \begin{matrix}{x}_{i} ( t ) , & fitness ( {x}_{i} ( t ) ) \leq {v}_{i} ( t + 1 ) \\ {v}_{i} ( t + 1 ) , & fitness ( {x}_{i} ( t ) ) > {v}_{i} ( t + 1 )\end{matrix} \qquad ( 12 )$$

wherein fitness(*) denoted the fitness value of a hummingbird, and if the candidate food source had lower fitness than a current food source, the hummingbird would abandon the current food source and stay at a newly generated candidate food source vᵢ(t+1) for feeding; and the visit table was updated accordingly.
Step 4.2.5: the iteration count was determined, wherein if the iteration count was a multiple of a predefined migration coefficient n, enhanced taboo territorial foraging would be performed.
Step 4.2.5.1: the number of hummingbirds for enhanced foraging was determined by selecting a random integer randint (randint∈[2,3,4,5]), and the number of enhanced foraging of each hummingbird was calculated as RSₙᵤₘ (RSₙᵤₘ=Popsize/randint).
Step 4.2.5.2: hummingbirds for enhanced territorial foraging were selected using a roulette wheel selection method.
Step 4.2.5.3: enhanced taboo territorial foraging was performed for each selected hummingbird for RSₙᵤₘ times, with the enhanced taboo territorial foraging method incorporating a taboo list based on the territorial foraging to ensure each search result for the enhanced taboo territorial foraging was distinct.
Step 4.2.5.4: the population and the visit table were updated.
Step 4.2.6: the iteration count was determined, wherein if the iteration count exceeded a predefined migration coefficient 2n, migration foraging would be performed.
Step 4.2.6.1: the hummingbird with a worst fitness value was selected and then migrated to a position of the hummingbird that had demonstrated an optimal fitness value thus far.
Step 4.2.6.2: the visit table was updated.
Step 4.2.7: an individual with an optimal fitness value was output, i.e., an optimal bottleneck process scheduling solution.

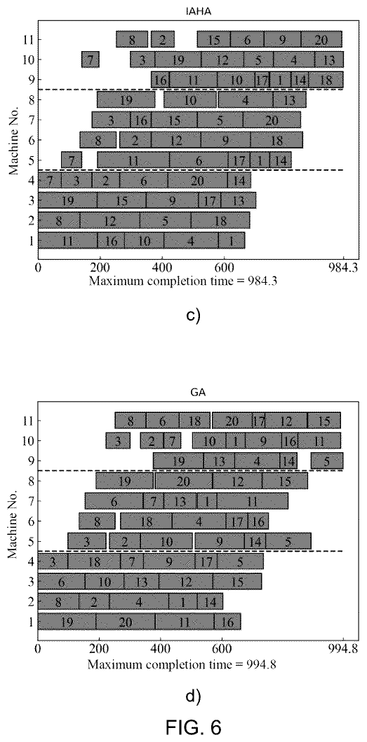

Table 4 presents a performance comparison of the algorithms described in the present disclosure for the aforementioned case. The comparison was conducted by running the IAHA and a genetic algorithm (GA) 20 times each. It can be observed that IAHA significantly outperformed the traditional FA in terms of both time efficiency and algorithm performance. Moreover, IAHA also demonstrated superior performance compared to the first-in-first-out (FIFO) rule and the NEH heuristic rule. FIG. 6 is a Gantt chart illustrating four scheduling methods (IAHA, GA, FIFO, NEH) for bottleneck processes according to the present disclosure.

TABLE 4
Algorithm Performance Comparison Table

| | IAHA | GA | FIFO | NEH |
|---|---|---|---|---|
| Maximum Fitness | 994.5 | 999.1 | 1110.06 | 1003.55 |
| Value/Unit Time | | | | |
| Minimum Fitness | 974.3 | 993.81 | 1110.06 | 1003.55 |
| Value/Unit Time | | | | |
| Average Fitness | 984.84 | 993.81 | 1110.06 | 1003.55 |
| Value/Unit Time | | | | |
| Average Time | 6.05 | 10.99 | 0.0009 | 0.06 |
| consumption/s | | | | |

Step 4.3: the bottleneck process scheduling solution was output through the intelligent scheduling sub-module.
Step 5: based on a rule library, the user selected rules for each process in advance; and combining the bottleneck process scheduling solution obtained from the intelligent scheduling sub-module, the rule-based scheduling sub-module generated a global scheduling solution and transmitted the global scheduling solution to the GUI module for arranging production; and specific steps were as follows:
a heuristic rule library of the rule-based scheduling sub-module comprised a heuristic processing sequence rule library and a heuristic equipment unit selection rule library; the processing sequence rule library comprised rules such as a shortest-processing-time-first rule, a longest-processing-time-first rule, a first-in-first-out rule, and an earliest-due-date-first rule, among others; the equipment unit selection rule library comprised rules such as selecting an equipment unit with shortest processing time, selecting an equipment unit with shortest machine changeover time, selecting an equipment unit with highest precision, selecting an equipment unit with lowest precision, selecting an equipment unit capable of processing most order types, selecting an equipment unit capable of processing fewest order types, among others;
Step 5.1: corresponding heuristic rules were selected for each process in advance;
Step 5.2: a global scheduling solution was generated using the processing sequence rule and the equipment unit selection rule for each process; wherein in this case, since the production capacity of non-bottleneck processes was relatively abundant, the FIFO rule was employed to select orders for processing, and the first-available-machine (FAM) rule was employed to select equipment units.
Step 5.3: the global scheduling solution was transmitted to the GUI module for arranging production.

Regarding the rapid-response intelligent scheduling system, it adopts a modular design as a whole, with a dedicated chip at its core, integrating multiple functional modules and corresponding components to construct a hardware architecture that tightly aligns with the logical loop of “bottleneck identification—intelligent scheduling—global scheduling solution generation.”

Specifically, the intelligent scheduling system comprises a GUI module, a bottleneck identification module, and a scheduling module. The GUI module is used to transmit workshop operation data and scheduling data, as well as to receive the global scheduling solution. The bottleneck identification module identifies all bottleneck processes using the “buffer-bottleneck index” method. The scheduling module includes an intelligent scheduling sub-module and a rule-based scheduling sub-module. The intelligent scheduling sub-module addresses bottleneck process scheduling problems using an improved IAHA, generating a bottleneck scheduling solution. The rule-based scheduling sub-module allows users to select rules from a rule base and, in combination with the bottleneck scheduling solution, generates the global scheduling solution.

More specifically, each module uses a dedicated chip as the core for computation and control, and all modules are interconnected via a high-speed bus to form an integrated system. The GUI module, serving as the data interaction hub, uses a BGA connector to enable high-speed access to workshop operation data (such as process capacity, buffer status, and order information), and pairs with a DLP display driver chip to visualize the scheduling solution, forming a bridge between the system and the user. The bottleneck identification module focuses on the “buffer-bottleneck index” logic, using capacitive proximity sensors to capture real-time WIP accumulation in buffers, and a dedicated ALU chip to perform parallel computation of bottleneck indices for each process, thereby accurately identifying all bottleneck processes and providing critical targets for subsequent scheduling. The intelligent scheduling sub-module implements the IAHA algorithm in hardware, using an FPGA to perform population initialization based on an improved NEH heuristic, a crossbar switch chip to efficiently execute guided foraging and territorial foraging operations, and SRAM to cache intermediate data, ensuring rapid solution of the bottleneck scheduling model. The rule-based scheduling sub-module relies on a rule library stored in NOR Flash (covering the processing sequence rule and the equipment unit selection rule), and uses a CPLD chip to synthesize the global scheduling solution based on user-selected rules and the bottleneck scheduling result. The intelligent scheduling system may further comprise a system control module, which employs an industrial-grade microcontroller to coordinate the timing of all modules, ensuring that the entire process—from data input to solution output—follows the steps in an orderly manner.

This architectural not only faithfully reflects the three-level module structure of “GUI module—bottleneck identification module—scheduling module”, but also transforms the algorithmic logic into a deployable physical system through hardware-based dedicated chips and components. It realizes the core of “bottleneck identification—bottleneck optimization—global coordination,” providing complete hardware-level support for efficient scheduling in semiconductor packaging and testing workshops.

The present disclosure adopts the “buffer-bottleneck index” bottleneck identification method, which, compared to conventional methods that rely solely on a single indicator (such as processing time or equipment utilization), overcomes the shortcomings of partial identification and susceptibility to misjudgment. It enables accurate identification of all bottleneck processes by comprehensively considering multiple factors such as buffer accumulation, production load, and quality impact. The present disclosure employs an improved IAHA for bottleneck process scheduling. Compared to traditional optimization algorithms such as GA, it addresses the issues of slow convergence and susceptibility to local optima. By improving population initialization, dynamically selecting foraging strategies, and introducing enhanced taboo and migration mechanisms, this disclosure significantly improves scheduling efficiency and accuracy. The present disclosure also adopts a rule-based scheduling technique that includes the processing sequence rule library and the equipment unit selection rule library. Compared to conventional fixed scheduling rules (such as simple “first-in-first-out rule”), it overcomes the limitation of inflexibility in adapting to different process characteristics. It allows users to select rules based on specific needs and, in combination with the bottleneck scheduling solution, generates a globally optimal scheduling solution. Furthermore, the present disclosure adopts a system architecture in which the GUI module, bottleneck identification module, and scheduling module work in coordination. Compared to conventional workshop systems with fragmented data transmission architectures, it overcomes the drawback of high response latency and realizes a closed-loop process from data input to global scheduling solution generation, thereby enhancing the system's response speed.

It is understood for those having ordinary skills in the art that all or part of the steps in the method for implementing the above embodiments can be completed by instructing the processor through the programs, and the programs can be stored in the computer-readable storage medium. The storage medium is a non-transitory medium, such as a random-access memory, a read-only memory, a flash memory, a hard disk, a solid-state drive, a magnetic tape, a floppy disk, an optical disc, or any combination thereof. The storage medium may be any available medium that can be accessed by a computer or a data storage device such as a server or a data center that includes one or more available media. The available medium may be a magnetic medium (e.g., a floppy disk, a hard disk, and a magnetic tape), an optical medium (e.g., a digital video disc (DVD)), or a semiconductor medium (e.g., a solid state disk (SSD)).

It should be noted that the memory may include a random access memory (RAM) and may also include non-volatile memory, such as at least one disk storage. Similarly, the processor may also be a general-purpose processor, including a central processing unit (CPU), a network processor (NP), etc.; it may also be a digital signal processor (DSP), an application specific integrated circuit (ASIC), a field programmable gate array (FPGA), or other programmable logic devices, discrete gates or transistor logic devices, discrete hardware components.

It should be further clarified that the above description provides detailed explanations only for specific examples of the present disclosure and should not be construed as limiting the scope of the present disclosure. Any equivalent modifications or substitutions made by those skilled in the art are encompassed within the scope of the present disclosure. Therefore, all equivalent variations and modifications made without departing from the spirit and scope of the present disclosure shall fall within the scope of the present disclosure.

1. A rapid-response intelligent scheduling method for a semiconductor packaging and testing workshop, comprising three modules:
a GUI module, a bottleneck identification module, and a scheduling module; wherein the scheduling module comprises an intelligent scheduling sub-module and a rule-based scheduling sub-module, and following steps are accomplished through these modules:
Step 1: a user transmits workshop operation data to the bottleneck identification module by means of the GUI module;
Step 2: the bottleneck identification module identifies all bottleneck processes by means of a “buffer-bottleneck index” bottleneck identification method;
Step 3: the GUI module and the bottleneck identification module transmit workshop scheduling data and a bottleneck process identification result to the scheduling module, respectively;
Step 4: the intelligent scheduling sub-module establishes a bottleneck process scheduling model in a semiconductor packaging and testing workshop, utilizes an IAHA to schedule the bottleneck processes, and inputs a bottleneck process scheduling solution into the rule-based scheduling sub-module; and
Step 5: based on a rule library, the user selects rules for each process in advance; and combining the bottleneck process scheduling solution obtained from the intelligent scheduling sub-module, the rule-based scheduling sub-module generates a global scheduling solution and transmits the global scheduling solution to the GUI module for arranging production.

2. The rapid-response intelligent scheduling method for a semiconductor packaging and testing workshop according to claim 1, wherein Step 2 is specifically as follows:
Step 2.1: determining whether there is an accumulation of work-in-progress in a buffer of process s, where s∈1. . . . S and S denotes the total number of processes, wherein if yes, the process is identified as a bottleneck process, and Step 2.3 is performed; otherwise, Step 2.2 is performed;
Step 2.2: calculating a bottleneck index for each process using Formula (1) and Formula (2), and determining whether the process has a highest bottleneck index, wherein if yes, Step 2.3 is performed; otherwise, Step 2.4 is performed;
$${I}_{BN} = {w}_{t} \times \frac{{l}_{s}}{{c}_{s}} + {w}_{b} \times \frac{{B}_{s}^{in}}{{B}_{s}^{all}} + {w}_{q} \times {G}_{s ( {q}_{ac} )} , s = 1 , … , S \qquad ( 1 )$$
$${c}_{s} = {T}_{s} - {F}_{s} ( t ) \qquad ( 2 )$$
wherein I_{BN} denotes the bottleneck index; wₜ, w_{b}, and w_{q} denote influence weights of the number of products produced by the process, the process buffer, and product quality on a bottleneck degree, respectively, satisfying wₜ+w_{b}+w_{q}=1; cₛ and lₛ denote production capacity and a production load, respectively; Tₛ denotes assumed available processing capacity; Fₛ(t) denotes a variation quantity in the production capacity of process s due to changes in actual production conditions;
$${B}_{s}^{all} and {B}_{s}^{in}$$
denote a maximum loadable quantity of the buffer and the quantity of newly added products in the buffer, respectively; G_{s(q}_{_{ac}}₎ denotes an influence function of quality assurance capability (q_{ac}) on the bottleneck degree; and (q_{ac}) is a comprehensive reflection of the quality capability and quality requirements;
Step 2.3: recording the process as a bottleneck process and performing Step 2.5;
Step 2.4: recording the process as a non-bottleneck process and performing Step 2.5;
Step 2.5: determining whether the process is the last one; wherein if yes, Step 2.6 is performed; otherwise, Step 2.1 is performed; and
Step 2.6: terminating the determination and outputting all bottleneck processes to the scheduling module.

3. The rapid-response intelligent scheduling method for a semiconductor packaging and testing workshop according to claim 2, wherein Step 4 is specifically as follows:
Step 4.1: establishing a bottleneck process scheduling model in a semiconductor packaging and testing workshop, with the model comprising all bottleneck processes and processes between them;
Step 4.2: optimizing the bottleneck process scheduling model in the workshop using an IAHA;
Step 4.2.1: initializing a population by means of an improved NEH heuristic rule instead of randomly generating an initial population;
Step 4.2.2: initializing a food source visit table;
Step 4.2.3: setting an iteration count to Iteration and utilizing the IAHA to conduct an optimization search;
Step 4.2.4: replacing a 50% probability-based guided foraging method or territorial foraging method with an improved foraging method based on a foraging determination formula;
Step 4.2.5: determining the iteration count, wherein if the iteration count is a multiple of a predefined migration coefficient n, enhanced taboo territorial foraging is performed;
Step 4.2.6: determining the iteration count, wherein if the iteration count exceeds a predefined migration coefficient 2n, migration foraging is performed;
Step 4.2.7: outputting an individual with an optimal fitness value as an optimal bottleneck process scheduling solution; and
Step 4.3: outputting the bottleneck process scheduling solution through the intelligent scheduling sub-module.

4. The rapid-response intelligent scheduling method for a semiconductor packaging and testing workshop according to claim 3, wherein Step 4.2.1 is specifically as follows:
Step 4.2.1.1: calculating total processing time for all orders as
$$T {P}_{j} = \sum \frac{{p}_{j , i}}{\sum {v}_{k , j}} ,$$
wherein j∈2 . . . n, representing a sum of ratios of an order's processing time at each stage to a sum of processing speeds at each stage; and permuting the orders in non-increasing order of TPⱼ to obtain an initial sequence π⁰={π⁰(1), π⁰(2), . . . , π⁰(n)};
Step 4.2.1.2: extracting first two orders π⁰(1) and π⁰(2) from π⁰ and permuting their order to obtain two schedules {π⁰(1), π⁰(2)} and {π⁰(2), π⁰(1)}; evaluating the two partial schedules and selecting the one with a smaller makespan as a current schedule, denoted as π={π(1), π(2)};
Step 4.2.1.3: extracting a j-th order π⁰(j) from π⁰ and inserting it into all possible positions of π to obtain j partial permutations; evaluating these partial permutations and selecting the one with a smallest makespan as the current schedule π;
Step 4.2.1.4: setting j=j+1, wherein if j≤n−1, Step 4.2.1.3 is performed; otherwise, the current schedule π is output;
Step 4.2.1.5: based on the current schedule π={π(1), π(2), . . . , π(n)}, randomly selecting integers l, and m such that l<m≤n, and swapping l-th and m-th orders in the current schedule π to obtain a new individual;
Step 4.2.1.6: repeating Step 4.2.1.5 until a set of hummingbird individuals with a size of Popsize/2 is generated; and
Step 4.2.1.7: directly generating another Popsize/2 identical hummingbird individuals using a result of an improved NEH heuristic algorithm, and combining them with the set of individuals generated in Step 4.2.1.6 to obtain an initial population.

5. The rapid-response intelligent scheduling method for a semiconductor packaging and testing workshop according to claim 4, wherein Step 4.2.4 is specifically as follows:
Step 4.2.4.1: selecting a foraging method using a foraging determination formula;
wherein original 50% probability-based foraging methods are replaced through the foraging determination formula for choosing between guided foraging and territorial foraging, facilitating an increased selection probability for the guided foraging in early iterations to enhance global exploration capability, while improving an increased selection probability for the territorial foraging in later iterations to strengthen local optimization performance;
$$GT = {GT}_{max} - ( {GT}_{max} - {GT}_{min} ) \times \frac{it}{Iteration} \qquad ( 10 )$$
$$\{ \begin{matrix}{v}_{i} ( t + 1 ) = {f}_{Guided} ( {v}_{i , tar} ( t ) , {x}_{i} ( t ) ) , rand \geq GT \\ {v}_{i} ( t + 1 ) = {f}_{Territorial} ( {x}_{i} ( t ) ) , rand < GT\end{matrix} \qquad ( 11 )$$
wherein GT denotes a foraging determination coefficient; GTₘₐₓ and GTₘᵢₙ denote maximum and minimum foraging determination coefficients, respectively, with values ranging in
$$[ O , 0.5 \times \frac{{Popsize}_{\geq mean}}{Popsize} ] ,$$
wherein Popsize denotes a population size, and Popsize_{≥mean} denotes the number of individuals in the population whose fitness values are greater than or equal to an average fitness value of the population; it denotes the iteration count; Iteration denotes a maximum iteration count; vᵢ(t+1) denotes a candidate food source position of an i-th hummingbird at time t+1; f_{Guided}(v_{i,tar}(t), xᵢ(t)) denotes a guided foraging search, wherein xᵢ(t) denotes a food source position of the i-th hummingbird at time t; v_{i,tar}(t) denotes a target food source position that the i-th hummingbird intends to visit; and f_{Territorial}(xᵢ(t)) denotes a territorial foraging search;
Step 4.2.4.2: searching for better food sources through three flight modes;
wherein when a generated random number rand≥GT, hummingbirds choose the guided foraging, comprising three flight modes: selecting one processing position to swap two orders, selecting multiple consecutive positions to swap two order blocks, and selecting multiple positions to swap multiple orders; and
when the generated random number rand<GT, the hummingbirds choose the territorial foraging, comprising three flight modes: selecting two positions to swap two orders, selecting multiple consecutive positions to swap intra-block orders, and selecting multiple positions to swap multiple orders; and
Step 4.2.4.3: updating the population and the visit table;
wherein a position of an i-th food source is updated as follows:
$${x}_{i} ( t + 1 ) = \{ \begin{matrix}{x}_{i} ( t ) , & fitness ( {x}_{i} ( t ) ) \leq {v}_{i} ( t + 1 ) \\ {v}_{i} ( t + 1 ) , & fitness ( {x}_{i} ( t ) ) > {v}_{i} ( t + 1 )\end{matrix} \qquad ( 12 )$$
wherein fitness(*) denotes the fitness value of a hummingbird, and if the candidate food source has lower fitness than a current food source, the hummingbird abandons the current food source and stays at a newly generated candidate food source vᵢ(t+1) for feeding; and the visit table is updated accordingly.

6. The rapid-response intelligent scheduling method for a semiconductor packaging and testing workshop according to claim 5, wherein Step 4.2.5 is specifically as follows:
Step 4.2.5.1: determining the number of hummingbirds for enhanced foraging by selecting a random integer randint with randint∈[2,3,4,5], and calculating the number of enhanced foraging of each hummingbird as RSₙᵤₘ with RSₙᵤₘ=Popsize/randint;
Step 4.2.5.2: selecting hummingbirds for enhanced territorial foraging using a roulette wheel selection method;
Step 4.2.5.3: performing enhanced taboo territorial foraging for each selected hummingbird for RSₙᵤₘ times, with the enhanced taboo territorial foraging method incorporating a taboo list based on the territorial foraging to ensure each search result for the enhanced taboo territorial foraging is distinct; and
Step 4.2.5.4: updating the population and the visit table.

7. The rapid-response intelligent scheduling method for a semiconductor packaging and testing workshop according to claim 6, wherein Step 4.2.6 is specifically as follows:
Step 4.2.6.1: selecting the hummingbird with a worst fitness value and migrating it to a position of the hummingbird that has demonstrated an optimal fitness value thus far; and
Step 4.2.6.2: updating the visit table.

8. The rapid-response intelligent scheduling method for a semiconductor packaging and testing workshop according to claim 4, wherein Step 5 is specifically as follows:
a heuristic rule library of the rule-based scheduling sub-module comprises a heuristic processing sequence rule library and a heuristic equipment unit selection rule library;
the processing sequence rule library comprises one or more rules of a shortest-processing-time-first rule, a longest-processing-time-first rule, a first-in-first-out rule, and an earliest-due-date-first rule;
the equipment unit selection rule library comprises one or more rules of selecting an equipment unit with shortest processing time, selecting an equipment unit with shortest machine changeover time, selecting an equipment unit with highest precision, selecting an equipment unit with lowest precision, selecting an equipment unit capable of processing most order types, and selecting an equipment unit capable of processing fewest order types;
Step 5.1: selecting corresponding heuristic rules for each process in advance;
Step 5.2: generating a global scheduling solution using the processing sequence rule and the equipment unit selection rule for each process; and
Step 5.3: transmitting the global scheduling solution to the GUI module for arranging production.

9. A rapid-response intelligent scheduling system for a semiconductor packaging and testing workshop, comprising three parts: a GUI module, a bottleneck identification module, and a scheduling module; wherein the rapid-response intelligent scheduling system is configured to implement the rapid-response intelligent scheduling method according to claim 1; wherein
the GUI module is configured to transmit workshop operation data and workshop scheduling data, and receive a global scheduling solution;
the bottleneck identification module identifies all bottleneck processes by means of a “buffer-bottleneck index” bottleneck identification method; and
the scheduling module comprises an intelligent scheduling sub-module and a rule-based scheduling sub-module, the intelligent scheduling sub-module generates a bottleneck process scheduling solution by solving bottleneck process scheduling problems using an IAHA, and the rule-based scheduling sub-module generates the global scheduling solution by combining rules selected by a user from rule libraries with the bottleneck process scheduling solution.

10. The rapid-response intelligent scheduling system for a semiconductor packaging and testing workshop according to claim 9, further comprising a memory and a processor, wherein the memory stores computer programs, and when executing the computer programs, the processor implements the “buffer-bottleneck index” bottleneck identification method of the bottleneck identification module, the IAHA of the intelligent scheduling sub-module of the scheduling module, and the rule-based scheduling sub-module of the scheduling module.
